(19) United States
(12) Patent Application Publication
(10) Pub. No.: US 2019/0093422 A1
(43) Pub. Date: Mar. 28, 2019

(54) SLIDING DOOR FOR A RAIL VEHICLE

(71) Applicant: KNORR-BREMSE GESELLSCHAFT MIT BESCHRÄNKTER HAFTUNG, Mödling (AT)

(72) Inventors: Alois RITT, Amstetten (AT); Thomas WITZELNIG, Biberbach (AT)

(21) Appl. No.: 16/300,414

(22) PCT Filed: May 5, 2017
(86) PCT No.: PCT/EP2017/060824

§ 371 Date: Nov. 9, 2018

(30) Foreign Application Priority Data
May 10, 2016 (DE) 10 2016 108 637.1

(51) Int. Cl. E06B 7/23; E06B 3/70; B61D 19/00; B61D 19/02

(52) U.S. Cl. CPC E06B 7/2309; E06B 3/7015; E06B 7/231; E06B 2003/7086; B61D 19/02; E06B 2003/7023; E06B 2003/7051; B61D 19/005

(57) ABSTRACT

The invention relates to a sliding door for a rail vehicle, comprising an outer paneling and wherein a profiled section having a width of more than 10 mm is provided between the paneling on an outer edge of the door and/or on an inner edge of a cutout in the door, on a maximum of three sides of said edge.

### PRIORITY

This patent application is a U.S. National Phase of International Patent Application No. PCT/EP2017/060824, filed May 5, 2017, which claims priority to German Patent Application No. 10 2016 108 637.1 filed May 10, 2016, the disclosure of which being incorporated herein by reference in their entireties.

### FIELD

Disclosed embodiments relate to a sliding door for a rail vehicle with an outer paneling.

### BACKGROUND

A sliding door of the type is known in principle. A frame is produced normally from profiled tubes and then covered with paneling. The frame is closed, i.e., mutually connected profiled tubes are provided on all four sides of an outer edge of the door and/or at an inner edge of a cutout in the door (for example for a cutout for a window). According to the prior art, the frame substantially performs a supporting function for the door, while the paneling serves substantially for cladding this.

### SUMMARY

Disclosed embodiments provide an improved sliding door. In particular, the costs for production of this door, and for operation of a rail vehicle in which such a door is used, are reduced. This is achieved with a sliding door of the type cited initially, wherein a profile having a width of more than 10 mm is provided between the panels at an outer edge of the door and/or at an inner edge of a cutout in the door on a maximum of three sides of the edge.

In this way, the use of profiles for a sliding door is not fully excluded, but the door is constructed without a closed frame. Production of the door is thus substantially simplified since the time-consuming production of such a closed frame is no longer required. Because the interior is designed relatively simply due to the absence of the frame, heat and sound insulation can also easily be provided between the panels. In particular if this is compression-stable and provided over a large part of the door surface area, the wall thickness of the paneling may be low since the risk of indentation is significantly reduced by the internal insulation. In the end, the costs for both production of the door and operation of a rail vehicle in which such door is used, are reduced. Such a door therefore brings a double benefit.

### BRIEF DESCRIPTION OF FIGURES

Disclosed embodiments are explained in more detail below with reference to the attached Figures which show:

FIG. 1 an exemplary sliding door, depicted diagrammatically in front view and in outline, which terminates flush with a wall in a rail vehicle;

FIG. 2 a sliding door which does not terminate flush with a wall;

FIG. 3 an example of a frame construction according to the prior art;

FIG. 4 an example of a frame profile which also receives the seal according to the prior art;

FIG. 5 an example of a sliding door with a paneling chamfered in the edge region and configured with butt joints;

FIG. 6 as FIG. 5 but with overlapping paneling;

FIG. 7 an example of a sliding door with a rebate for a window and a chamfer to receive a door drive or similar;

FIG. 8 an example of a sliding door with an attached U-shaped profile for holding a seal;

FIG. 9 an example of a sliding door with an interior closed by a strip, and an applied T-shaped profile for holding a seal;

FIG. 10 an example of a sliding door in which a seal is held by a chamfer of the paneling;

FIG. 11 as FIG. 10 but without intermediate profile and with an insulation brought just up to the seal;

FIG. 12 as FIG. 11 but with an insulation enclosing the seal;

FIG. 13 as FIG. 11 but with a modified form of the seal which has a hollow region for engaging in a depression of the door;

FIG. 14 an example of a sliding door in which a seal has a plurality of depressions in which protrusions of the insulation engage;

FIG. 15 as FIG. 11 but with a seal configured as an edge protector;

FIG. 16 as FIG. 11 but with a seal as used in an embodiment according to FIG. 1; and

FIG. 17 an example of a sliding door in which a seal holds a window.

### DETAILED DESCRIPTION

Production of conventional rail vehicle sliding doors with outer panelings is very time-consuming since a plurality of frame profiles must be joined together, usually by welding. Due to the heat transmission, in addition there is a relatively high risk of distortion of the frame, so under some circumstances this must be straightened before the paneling can be fitted. Also, such a door is very heavy since firstly the frame profiles must have a specific width in order to to be covered with paneling, and secondly the wall thickness of the paneling must be relatively great in order to guarantee adequate compression stability, or stability against indentation of the door in those regions in which no frame profile is provided between the panels. Because of the complex inner structure, no insulation is provided so the doors are relatively permeable to sound and heat. Overall, a door according to the prior art has considerable disadvantages which become significant in particular when used in a rail vehicle. Firstly, the production of such a door in itself is already very costly, and secondly, because of its high weight and poor heat insulation, it further increases the cost of running the rail vehicle since an increased drive power and heating and cooling power for the carriage interior are necessary.

Disclosed embodiments provide an improved sliding door. In particular, the costs for production of this door, and for operation of a rail vehicle in which such a door is used, are reduced. This is achieved with a sliding door of the type cited initially, wherein a profile having a width of more than 10 mm is provided between the panels at an outer edge of the door and/or at an inner edge of a cutout in the door on a maximum of three sides of the edge.

In this way, the use of profiles for a sliding door is not fully excluded, but the door is constructed without a closed frame. Production of the door is thus substantially simplified since the time-consuming production of such a closed frame is no longer required. Because the interior is designed relatively simply due to the absence of the frame, heat and sound insulation can also easily be provided between the panels. In particular if this is compression-stable and provided over a large part of the door surface area, the wall thickness of the paneling may be low since the risk of indentation is significantly reduced by the internal insulation. In the end, the costs for both production of the door and operation of a rail vehicle in which such door is used, are reduced. Such a door therefore brings a double benefit.

Optionally, a profile having a width of more than 10 mm is not provided between the panels at an outer edge of the door and/or at an inner edge of a cutout in the door on any side of the edge. Optionally, an insulating material is arranged between the panels and bonded thereto, in particular glued, in the region of at least 70% of the surface area of the door, preferably 80% of the area, and further preferably 90% of the area. In this way, the sliding door becomes particularly compression-stable and has a particularly high sound and heat insulation.

Optionally, at least one side of the edge is formed by a chamfer of the paneling. In this way, an insulation arranged between the panels, or the entire interior of the door, can easily be sealed. The chamfer significantly increases the stability of the paneling, whereby handling thereof during production of the sliding door is simplified. In addition, naturally also the stability of the sliding door is increased.

Optionally, the paneling is designed so as to be overlapping in the region of the edge. In this way, the paneling can be joined together particularly well, in particular glued or spot welded.

Optionally, the paneling is designed with butt joints in the region of the edge. This may give a largely flat surface in the region of the joint.

Optionally, at least one side of the edge is formed by a strip with a thickness of maximum 10 mm arranged between the panels. In this way, the interior of the sliding door can be sealed without a chamfer on the paneling being required. Production of the paneling is thus simplified.

Optionally, a profile is placed on the (chamfered) paneling in the region of the edge. In this context, it is advantageous if the profile has a U-shaped, I-shaped, T-shaped or open tubular cross-section. Thus a seal for the door can be inserted in or pushed onto this profile. Mounting of the seal is therefore very quick and hence economic.

Optionally, the sliding door comprises a seal which runs on at least one edge of the door and is held by the paneling and/or by an insulating material arranged between the panels and/or by a profile placed on the door. In this way, there is no need for a frame profile which, in addition to its function of supporting the door, serves to receive a seal. The structure of the door is therefore significantly simplified. In a variant, the paneling already present and/or an insulation already present is used to fix the seal. It is particularly advantageous here if a chamfer of the paneling engages in a depression, in particular a groove, in the seal. In this way, the paneling fulfils a double purpose since it not only covers the inner region of the door but also functions as a holder for the seal. Profiles specially provided for holding the seal are not therefore required, whereby the construction of the door is further simplified. Alternatively, a profile may also be placed on the door and serve to hold the seal, but have no essential supporting function.

Optionally, the seal has at least one hollow region which engages in a depression, in particular a groove, in the door. Since the hollow regions can be compressed relatively easily and greatly, the seal can be installed comparatively easily and fills even greater depressions in the door.

Optionally, the seal has at least one T-shaped or L-shaped extension which engages in a depression, in particular a groove, in the door. In this way, the seal can be held in the door with simple technical measures.

Optionally, the seal has an extension with a plurality of depressions, in which protrusions of the insulating material engage. In this way, the seal is held in the insulating material particularly well. In particular, the door can be fully assembled apart from foam-filling the inner region of the door.

Optionally, the door remains free from insulating material in the region of the seal. In this way, installation of the seal is simplified, or the door can be fully assembled apart from installation of the seal.

In the various embodiments described, the same parts carry the same reference signs or component designations, wherein the disclosure contained in the entire description can be transferred accordingly to the same parts with the same reference signs or same component designations. Also, positional data selected in the description, e.g. top, bottom, side etc., relate to the Figure immediately described and depicted and, on a position change, may be transferred correspondingly to the new position. Furthermore, individual features or feature combinations from the various exemplary embodiments described and depicted may in themselves constitute independent inventive solutions or solutions according to the invention.

All data on value ranges in the present description should be understood to include any and all part ranges thereof, e.g. the data 1 to 10 should be understood such that all part ranges are included, starting from the lower limit of 1 up to the upper limit of 10, i.e. all part ranges beginning with a lower limit of 1 or above and ending at an upper limit of 10 or less, e.g. 1 to 1.7, or 3.2 to 8.1, or 5.5 to 10.

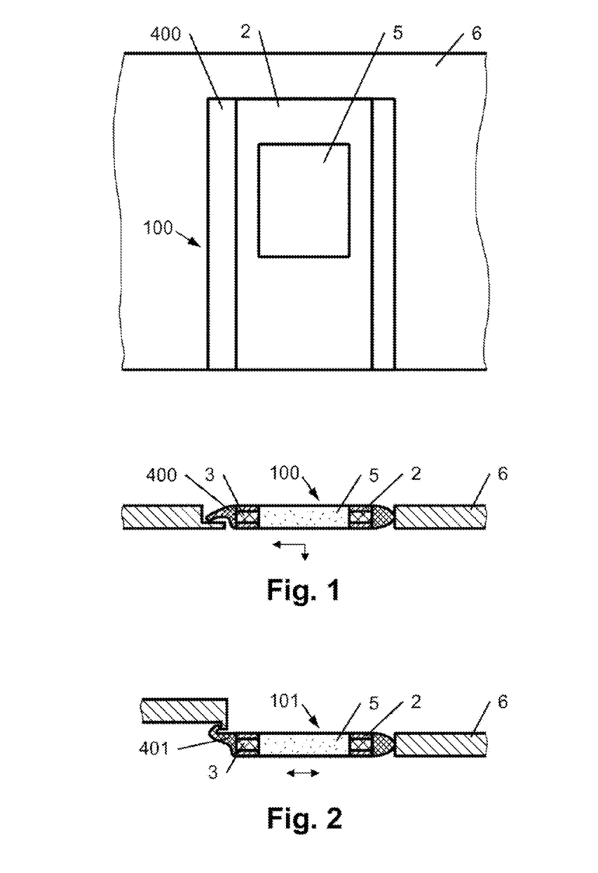

FIG. 1 depicts diagrammatically an exemplary sliding door 100 in a rail vehicle, in front view (top picture) and in outline (bottom picture). The door 100 comprises an outer paneling 2 which is made for example from a sheet metal, an insulating material 3 for example mineral wool arranged between the panels 2, seals 400 and a window 5. The sliding door 100 is installed in a wall 6 of a rail vehicle 6 (inner wall or outer wall) and may be moved in the arrow direction indicated.

FIG. 2 shows a modified form of a sliding door 101 with a slightly different seal 401, which on closing does not terminate flush with the wall 6 of the rail vehicle. Such sliding doors 101 are normally used in the interior of rail vehicles.

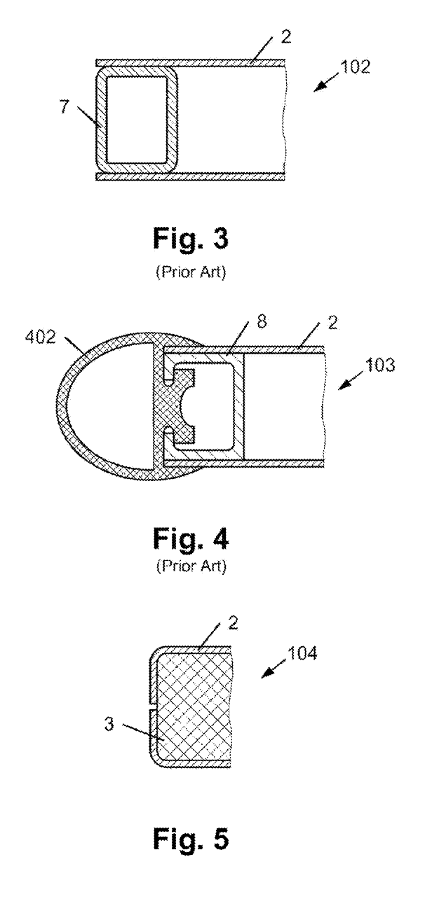

FIG. 3 now shows a cross-section through a sliding door 102 according to the prior art. A frame is formed using for example profiled tubes 7, and is then clad with the paneling 2. The frame is here closed, i.e. mutually connected profiled tubes 7 are provided on all four sides of an outer edge of the door 102 and/or at an inner edge of a cutout in the door 102 (for example a cutout for a window 5). According to the prior art, the frame substantially has a supporting function for the door 102, while the paneling 2 serves substantially for cladding thereof.

FIG. 4 shows a further example of a known arrangement for a sliding door 103. Instead of a closed rectangular tube 7, a U-shaped profile 8 or an open rectangular tube is provided on at least one side of the above-mentioned closed frame. Therefore it is possible to insert (clip) a seal 402 into the profile 8, or push this on. Depending on how many sides of an edge require such a seal 402, several rectangular tubes 7 may also be replaced by the profile 8 shown.

FIG. 5 now shows an embodiment of a sliding door 104 for a rail vehicle with an outer paneling 2, wherein a profile having a width of more than 10 mm is provided between the panels 2 at an outer edge of the door 104 and/or at an inner edge of a cutout in the door 104 on a maximum of three sides of the edge. The edge is formed by a chamfer of the paneling 2, as shown, on at least one side of the edge of the door 104. In this example, the paneling 2 is actually formed with butt joints in the region of the edge. An insulating material 3 is arranged between the panels 2 and bonded thereto, in particular glued.

In this way, an extremely form-stable door 104 is formed which at the same time is very light. The compression stability is achieved primarily by the insulating material 3, the bending stability primarily by the paneling 2. Suitable insulating materials may be foamed plastics, such as for example polystyrene, Styrodur and similar, and for example wood fiber honeycomb cores, also cardboard honeycomb cores. The paneling 2 may in particular be steel or aluminum sheets, or panels of fiber-reinforced plastic. The fibers may for example be glass fibers, Kevlar fibers, aramide fibers, carbon fibers and rock fibers.

If the depicted termination of the door 104 is provided on all four sides thereof, the insulating material practically may fill the entire area of the door 104. The door 104 is therefore not only extremely stable and lightweight, but also offers excellent heat and sound insulation.

Optionally, no separate frame profile is provided on any of the sides of the outer edge of the door 104 and/or at an inner edge of a cutout in the door 104. The door 104 therefore comprises particularly few components, whereby stockholding and production are significantly simplified.

In the form shown, the paneling 2 is open at the butt joint. Alternatively, it is possible that the paneling 2 is connected, in particular welded or glued, at the butt joint. Optionally, a mainly hollow shell may be produced which is then filled with insulation 3. For example, the shell may be filled with non-compressible plastic foam.

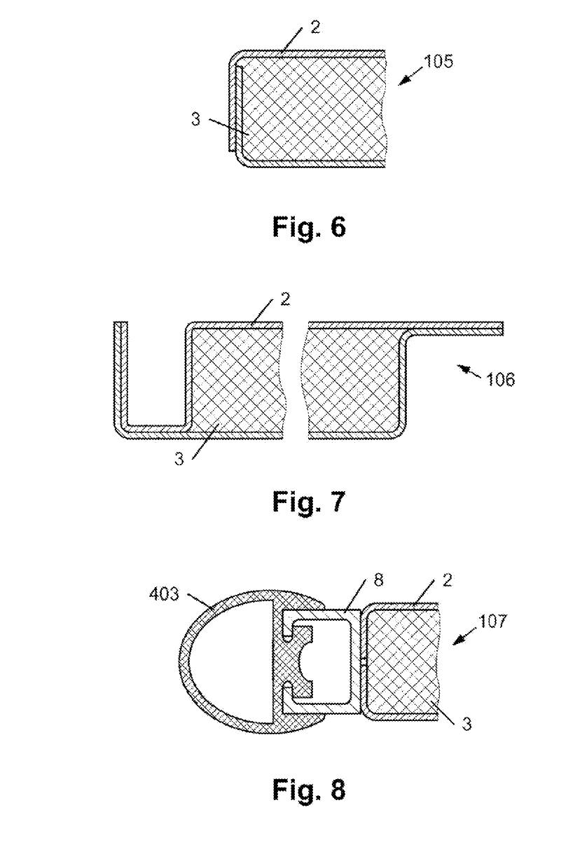

FIG. 6 shows a slightly modified form of a sliding door 105 in which the paneling 2 is formed so as to be overlapping in the region of the edge. In particular, the panels can thus be glued better or even spot welded.

FIG. 7 shows a further embodiment of a sliding door 106 in which the paneling 2 is again formed so as to be overlapping in the region of the edge. In contrast to the embodiment shown in FIG. 6, the sliding door 106 is not however terminated in a flat fashion but on one side has a chamfer which surrounds a hollow region. This hollow region may for example receive a mechanism for moving the sliding door 106, for example a guide rail or one or more rollers. Also, a drive for the sliding door 106 may be arranged in the hollow region, for example an electric or pneumatic linear drive. On the right-hand side, the sliding door 106 has a rebate in which for example a window pane 5 can be installed.

FIG. 8 now shows a variant of a sliding door 107 in which a profile 8 is placed on the paneling 2 in the region of the edge. Here, a U-shaped profile or open rectangular tube 8 is fitted, which - as shown in FIG. 4 - may receive a seal 403. In contrast to the embodiment shown in FIG. 4, in this case the profile 8 has no substantial supporting function and may consequently be formed softer than a conventional frame profile. Also, the profile 8 need only be placed on the sides of the door on which a seal 403 is required.

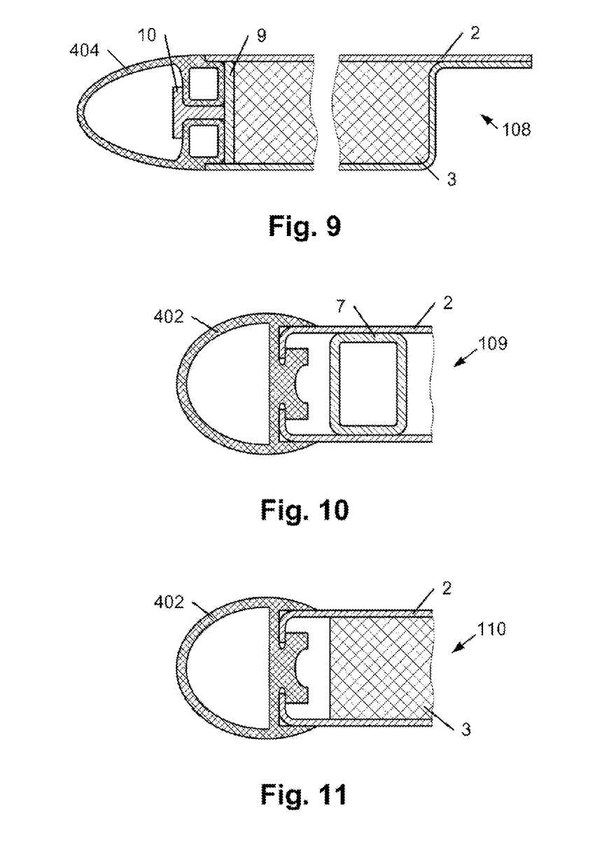

FIG. 9 shows a further embodiment of a sliding door 108. In the right-hand region a rebate is provided, as in the door 106 shown in FIG. 7. In the left-hand region however, the door 108 is terminated at least on one side by a strip 9 arranged between the panels 2. Since it has substantially no supporting function, the strip 9 is, for reasons of weight, preferably less than 10 mm thick. A T-shaped profile 10 is placed on this strip 9, and a seal 404 can be clipped or pressed onto the profile. In this example, the seal 404 has two hollow regions which engage in a depression, here in the grooves formed by the T-shaped profile 10.

Instead of the T-shaped profile 10, a profile with U-shaped, I-shaped or open tubular cross section may be provided. These profiles could also be placed on a door 107 shown in FIG. 8.

FIG. 10 furthermore shows a sliding door 109 for a rail vehicle, with an outer paneling 2 and a seal 402 running along at least one edge of the door 109, wherein the seal 402 is held by the paneling 2. In concrete terms, a chamfer of the paneling 2 engages in a depression, here in a groove, of the seal 402. For this, the seal 402 has a T-shaped extension which in turn engages in a depression, here in the groove formed by the chamfer of the paneling 2. Alternatively it would also be conceivable that, instead of the T-shaped extension, the seal 402 has two L-shaped extensions. As FIG. 10 shows, a rectangular tube 7 is arranged between the panels 2. Preferably, this is arranged only in the region of a seal 402 and is not part of a closed frame for the door 109. However, the features cited above (chamfer of paneling 2 engaging in a depression of the seal 402) could also be applied to a door which has a closed door frame according to the prior art. In this case, the rectangular tube 7 is part of the door frame but, in contrast to the arrangement shown in FIG. 3, is offset slightly towards the inside in order to be able to receive the seal 402.

FIG. 11 now shows a variant of a sliding door 110 in which an insulating material 3 is again provided between the panels 2. To facilitate installation of the seal 402, a region of the door 110 in the vicinity of the seal 402 remains free from insulating material 3.

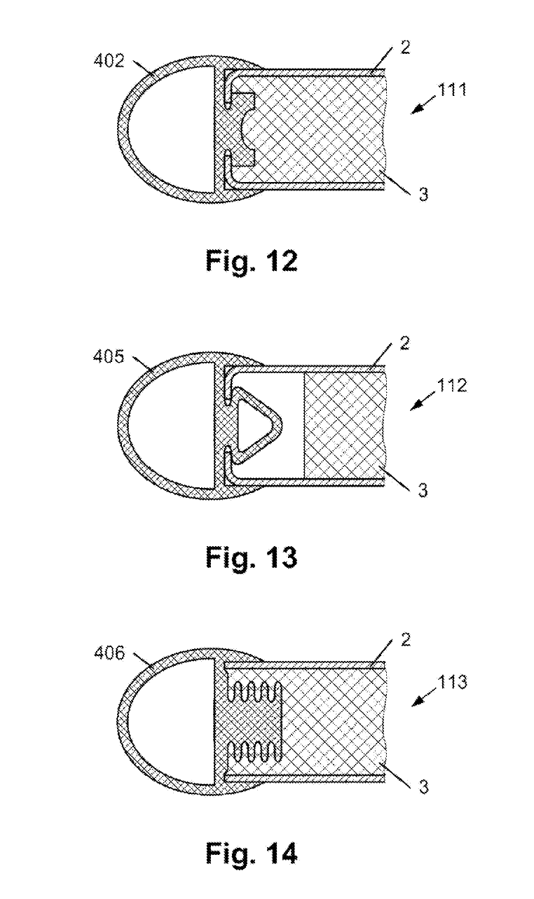

FIG. 12 shows a sliding door 111 which is very similar to the sliding door 110 shown in FIG. 11. In contrast however, the insulating material 3 extends up to the seal 402, or also surrounds this even partially. In this way, firstly the seal 402 is held better, and secondly the heat and sound insulation of the door 110 is improved.

FIG. 13 shows a sliding door 112 which again is very similar to the sliding door 110 shown in FIG. 11. In contrast however, the seal 405 has a slightly different form. This has a hollow region which engages in a depression, here in a groove of the door 112.

FIG. 14 shows a sliding door 113 for a rail vehicle, with an outer paneling 2 and a seal 406 running along at least one edge of the door 113, in which the seal 406 is held by the insulating material 3 arranged between the panels 2. In concrete terms, the seal 406 has an extension with a plurality of depressions in which protrusions of the insulating material 3 engage. Such an arrangement is produced for example by foam-filling a cavity between the panels 2 when the seal 406 is already fitted.

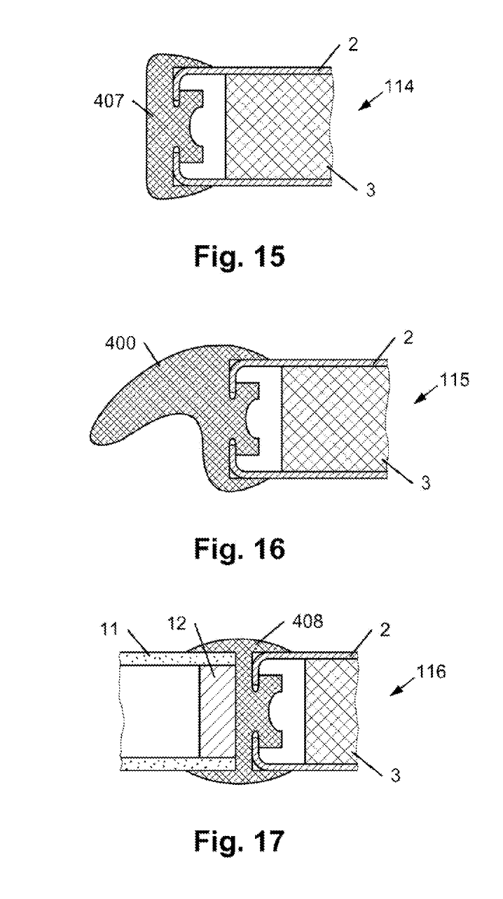

FIGS. 15 and 16 show further variants of a seal 400 and 407. The seal 407 terminates the door more or less flush, and may therefore also be used as an edge protector (without an explicit sealing function). The seal 400 is, however, inserted in an arrangement according to FIG. 1.

FIG. 17 finally shows a sliding door 116 with a special seal 408 which holds a window 5. The window 5 is an insulated glass window with two panes 11 and a spacer frame 12 arranged in-between.

Finally, it is pointed out that the retaining portions of the seals 400 . . . 408 shown may be provided as continuous profiles or also merely in portions. In the latter case, for example pin-like extensions may be considered which protrude into bores of the door 100 . . . 116.

The exemplary embodiments show possible variants of a sliding door 100 . . . 116 according to disclosed embodiments for a rail vehicle, wherein it must be pointed out here that the invention is not restricted to the variants thereof depicted especially, but rather various combinations of the individual embodiments are possible, and these possible variations lie within the capacity of the person skilled in this art because of the teaching on technical activity from the present invention. Also, all conceivable embodiment variants which are possible by combining individual details of the variants depicted and described, are included in the scope of protection.

In particular, it is established that a sliding door 100 . . . 116 for a rail vehicle may in reality also comprise more components than depicted or also fewer.

For the sake of good order, it should finally be pointed out that for better understanding of the structure of the sliding door 100 . . . 116, this and its components have been partially shown not to scale, and/or enlarged and/or reduced.

The object on which the independent inventive solutions are based may also be gathered from the description.

### LIST OF REFERENCE SIGNS

100 . . . 116 Sliding door
2 Paneling
3 Insulating material
400 . . . 408 Seal
5 Window
6 Wall
7 Profile tube
8 U-shaped profile/open rectangular profile
9 Strip
10 T-shaped profile
11 Pane
12 Spacer frame

1. A rail vehicle sliding door with an outer paneling comprising:
a plurality of panels;
wherein a profile having a width of more than 10 mm is provided between the the plurality of panels at an outer edge of the door and/or at an inner edge of a cutout in the door on a maximum of three sides of the edge.

2. The sliding door of claim 1, wherein the profile provided between the the plurality of panels at the outer edge of the door and/or at the inner edge of the cutout in the door on any side of the edge has a width of less than 10 mm.

3. The sliding door of claim 1, further comprising an insulating material is arranged between the plurality of panels and bonded thereto in the region of at least 70% of a surface area of the door.

4. [symbol] ,wherein at least one side of the edge is formed by a chamfer of the plurality of panels.

5. The sliding door of claim 1, wherein the plurality of panels overlap in the region of the edge.

6. [symbol] , wherein the plurality of panels include but joints in the region of the edge.

7. The sliding door of claim 1, wherein at least one side of the edge is formed by a strip with a thickness of maximum 10 mm arranged between the panels.

8. The sliding door of claim 1, wherein a profile is placed on the plurality of panels in the region of the edge.

9. The sliding door of claim 8, wherein the profile has a U-shaped, I-shaped, T-shaped or open tubular cross-section.

10. The sliding door of claim 1, further comprising a seal which runs on at least one edge of the door and is held by the plurality of panels and/or by an insulating material arranged between the plurality of panels and/or by a profile placed on the door.

11. The sliding door of claim 10, further comprising a chamfer of the paneling engages in a depression in the seal.

12. [symbol] wherein the seal has at least one hollow region which engages in a depression in the door.

13. The sliding door of claim 10, wherein the seal has at least one T-shaped or L-shaped extension which engages in a depression in the door.

14. The sliding door of claim 10, wherein the seal has an extension with a plurality of depressions, in which protrusions of the insulating material engage.

15. [symbol] , wherein remains free from insulating material in the region of the seal.
